(19) United States
(12) Patent Application Publication
(10) Pub. No.: US 2010/0321171 A1
(43) Pub. Date: Dec. 23, 2010

(54) System and Method for Satellite Aided Truck/Trailer Tracking and Monitoring

(76) Inventor: Rich Battista, Ashburn, VA (US)

Correspondence Address: LAW OFFICE OF DUANE S. KOBAYASHI, P.O. Box 4160, Leesburg, VA, 20177, US

(21) Appl. No.: 12/768,287

(22) Filed: Apr. 27, 2010

Related U.S. Application Data
(63) Continuation-in-part of application No. 12/333,048, filed on Dec. 11, 2008.
Application No. 12/333,048 is a continuation of application No. 11/518,520, filed on Sep. 11, 2006, now Pat. No. 7,468,927.
Application No. 11/518,520 is a continuation-in-part of application No. 11/639,424, filed on Dec. 15, 2006, now abandoned.
(60) Provisional application No. 60/715,596, filed on Sep. 12, 2005.
(60) Provisional application No. 60/721,540, filed on Sep. 29, 2005.
(60) Provisional application No. 60/750,793, filed on Dec. 16, 2005.
(60) Provisional application No. 60/750,785, filed on Dec. 16, 2005.
(60) Provisional application No. 60/751,661, filed on Dec. 20, 2005.
(60) Provisional application No. 60/752,896, filed on Dec. 23, 2005.

(51) Int. Cl. B60C 23/00

(52) U.S. Cl. 340/425.5

(57) ABSTRACT

A system and method for satellite aided vehicle monitoring. Tire pressure, mileage, and tachometer/speedometer information are generated by sensors that are affixed to different parts of a truck/trailer. Measurement data taken by the sensors is reported to a mobile terminal affixed to the vehicle. In one embodiment, the sensor data is transmitted to the mobile terminal using wireless communication. The mobile terminal transmits reports, which can include sensor information and position information, to a remote location via a communications satellite.

This application claims priority to non-provisional application Ser. No. 12/333,048, filed Dec. 11, 2008, which claims priority to U.S. Pat. No. 7,468,927, issued Dec. 23, 2008, which claims priority to provisional application No. 60/715,596, filed Sep. 12, 2005 and provisional application No. 60/721,540, filed Sep. 29, 2005. This application also claims priority to non-provisional application Ser. No. 11/639,424, filed Dec. 15, 2006, which claims priority to provisional application No. 60/750,793, filed Dec. 16, 2005, provisional application No. 60/750,785, filed Dec. 16, 2005, provisional application No. 60/751,661, filed Dec. 20, 2005, and provisional application No. 60/752,896, filed Dec. 23, 2005. Each of the above-identified applications are incorporated herein by reference in its entirety.

### BACKGROUND

1. Field of the Invention

The present invention relates generally to asset tracking and monitoring and, more particularly, to a system and method for satellite aided truck/trailer tracking and monitoring.

2. Introduction

Shipping companies typically maintain a large fleet of vehicles that are responsible for deliveries across an entire nation or continent. One of the keys of running a smooth shipping operation is to have a well-maintained fleet of vehicles. Where a fleet includes thousands of vehicles, this maintenance task represents a large administrative challenge. If this maintenance problem is neglected, greater than average repair costs can be incurred as vehicles are permitted to operate in less than optimal conditions, or in hazardous conditions such as when the vehicle requires repair. What is needed therefore is a mechanism that enables effective monitoring of operating conditions of trucks and trailers.

### SUMMARY

A system and/or method for satellite aided truck/trailer tracking and monitoring, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an embodiment of a satellite communications network that enables the monitoring of remote assets using a collection of sensors.

FIG. 2 illustrates an embodiment of a wireless local area network.

FIG. 3 illustrates a flowchart of a process of reporting sensor data to a centralized facility.

FIG. 4 illustrates an embodiment of a wireless device that is coupled to a sensor.

FIG. 5 illustrates a flowchart of a process of communication method that conserves power.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

As noted, running a large fleet of vehicles represents a large administrative problem. One aspect of this administrative problem is ensuring that routine maintenance is performed on the vehicles. In general, this administrative problem is exacerbated by the fact that the vehicles and their loads are distributed over a large geographic area as they traverse their assigned routes.

It is therefore a feature of the present invention that maintenance related information can be gained from individual vehicles as they travel on their assigned route using a satellite aided tracking and monitoring system. In one embodiment, this satellite aided tracking and monitoring system is based on a mobile terminal that is coupled to one or more sensors that are designed to report on the condition of various aspects of the service vehicle. In general, these one or more sensors can be used to report status information or the occurrence of any events at the service vehicle. Data generated by the one or more sensors is collected by the mobile terminal, which reports the sensor data to a centralized facility using a communications satellite. In one embodiment, the mobile terminal can also report position information that is derived from the reception of satellite position signals such as that generated by the GPS satellite network.

To enable the reporting of sensor data along with position information, the principles of the present invention provide sensors with an interface to a mobile terminal that reports the position and sensor information via wireless communication (e.g., satellite communication) to a centralized facility. The interface between the sensors and the mobile terminal can represent a significant technical and economic challenge. Consider, for example, an implementation where the mobile terminal is mounted on a wheel of a trailer. As would be appreciated, cable connections between this mobile terminal and a sensor on a wheel would be impractical.

The principles of the present invention are designed to meet these needs by not only implementing a wireless connection between a mobile terminal and one or more sensors that facilitates two-way communication, but also operating such a wireless network in manner that minimizes the power required by the mobile terminal and sensor devices.

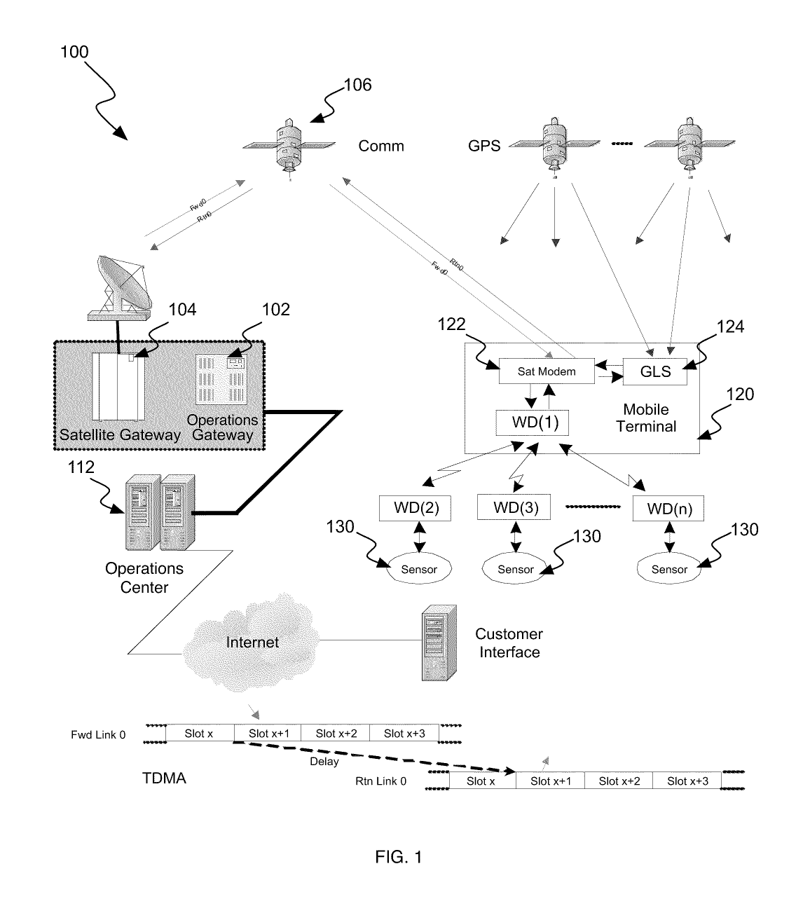

Prior to describing the details of the principles of the present invention, a description of an embodiment of an operational context is first provided. FIG. 1 illustrates an embodiment of a satellite network 100 that includes operations gateway 102, communicating with mobile terminal 120 on an asset. Communication between operations gateway 102 and mobile terminal 120 is facilitated by satellite gateway 104 at the ground station and satellite modem 122 in mobile terminal 120. Both satellite gateway 104 and satellite modem 122 facilitate communication using one forward and one return link (frequency) over communications satellite 106.

In one embodiment, the satellite communication is implemented in a time division multiple access (TDMA) structure, which consists of 57600 time slots each day, per frequency or link, where each slot is 1.5 seconds long. On the forward link, operations gateway 102 sends a message or packet to mobile terminal 120 on one of the 1.5 second slots. Upon receipt of this message or packet, mobile terminal 120 would then perform a GPS collection (e.g., code phase measurements) using Global Locating System (GLS) module 124 or to perform sensor measurements and transmit the data back to operations gateway 102 on the return link, on the same slot, delayed by a fixed time defined by the network. In one embodiment, the fixed delay defines a length of time that enables mobile terminal 120 to decode the forward packet, perform the data collection and processing, and build and transmit the return packet.

In one embodiment, mobile terminal 120 can be configured to produce periodic status reports. In this configuration, mobile terminal 120 would wake up periodically, search for its assigned forward slot, perform data collection and processing, and transmit the status report on the assigned return slot. In another embodiment, mobile terminal 120 can be configured to produce a status report upon an occurrence of an event (e.g., door opening, motion detected, sensor reading, etc.). In this configuration, mobile terminal 120 would wake up upon occurrence of an event, search for an available forward slot, perform data collection and processing, and transmit the status report on the return slot corresponding to the identified available forward slot.

Upon receipt of a status report from mobile terminal 120, operations gateway 102 passes the information to operations center 112, where the information is processed and passed to a customer via the Internet. A detailed description of this communications process is provided in U.S. Pat. No. 6,725,158, entitled “System and Method for Fast Acquisition Position Reporting Using Communication Satellite Range Measurement,” which is incorporated herein by reference in its entirety. As would be appreciated, the principles of the present invention can also be applied to other satellite communications systems as well as to terrestrial communications systems.

In the embodiment of FIG. 1, the wireless interface uses wireless device WD(1) that is coupled to satellite modem 122, and wireless devices WD(2)-WD(n) that are coupled to respective sensors 130. The wireless network formed by wireless devices WD(1)-WD(n) enables mobile terminal 120 to interface to the plurality of wireless sensors 130. It should be noted that this wireless network can operate independently from the standard functions of mobile terminal 120. One example of such a wireless sensor interface is that described in U.S. Pat. No. 7,468,927, which is incorporated herein by reference in its entirety.

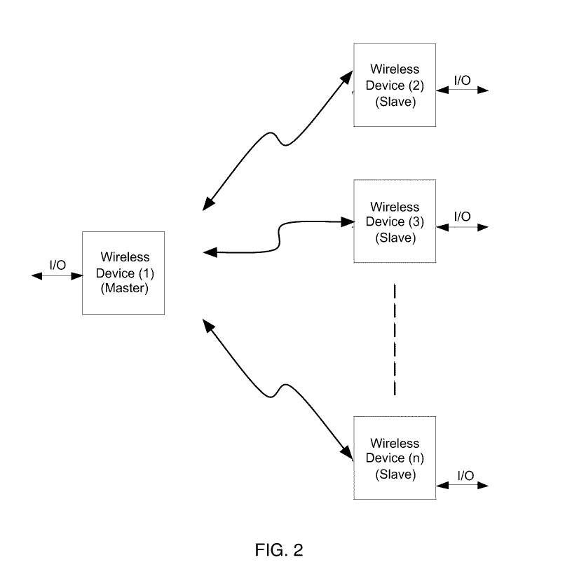

In one embodiment, the wireless interface uses wireless devices that can be configured as master or slave devices. FIG. 2 illustrates an embodiment of a master-slave configuration for the wireless devices. As illustrated, wireless device WD(1) 120 is configured as a master device, while wireless devices WD(2)-WD(n) that are coupled to individual sensors are configured as slave devices. This master-slave configuration enables independent communication between the wireless devices. Each wireless device can be an independently addressable unit having its own processor, power management, sleep timers and other apparatus that allows it to perform low data rate communications, conserve power and reduce cost. It is a feature of the present invention that this wireless interface has the capability to transfer binary data in both directions to and from a sensor device. In one embodiment, slave devices only transmit in acknowledgment from a request from a master device. This type of half-duplex communication exhibits good performance in low data rate systems and for avoiding collisions.

In one embodiment, as illustrated in FIG. 1, wireless device WD(1) 120 is integrated with mobile terminal 120. In an alternative embodiment, wireless device WD(1) is physically separated from mobile terminal. In one example, wireless device WD(1) can communicate with the mobile terminal via a wired data connection.

With the wireless sensor interface, sensors can be placed at locations that cannot accommodate a wired sensor connection. For example, consider a sensor that is located on a wheel or hub. Here, a satellite aided tracking and monitoring system that is coupled wirelessly to a wheel sensor would open up an entirely new range of management applications.

For example, consider the safety problem posed by wheels with a low tire pressures. This issue is particularly problematic on heavy over-the-road vehicles, which account for a significant number of vehicle accidents every year. Low pressures cause tires to generate excess heat, which degrades the tire carcass, causing it to wear prematurely, thereby contributing to early carcass failures.

A large number of these types of vehicles are members of fleets, whose maintenance is centrally managed. Early automatic detection of low tire pressures will enable the vehicle or fleet operator to correct deficiencies early, avoid premature tire failure, reduce operating costs including fuel consumption, and improve vehicular safety.

One of the advantages of wirelessly coupling a mobile terminal to a tire pressure sensor is the real-time feedback regarding vehicle operating conditions. As would be appreciated, performing a vehicle check at vehicle stops would not provide enough monitoring granularity to ensure that the vehicle is in good operating condition throughout the entire route of travel. It is therefore a feature of the present invention that the monitoring of pressure in the tires on a vehicle can be performed anywhere over a large service area using a satellite aided tracking and monitoring system.

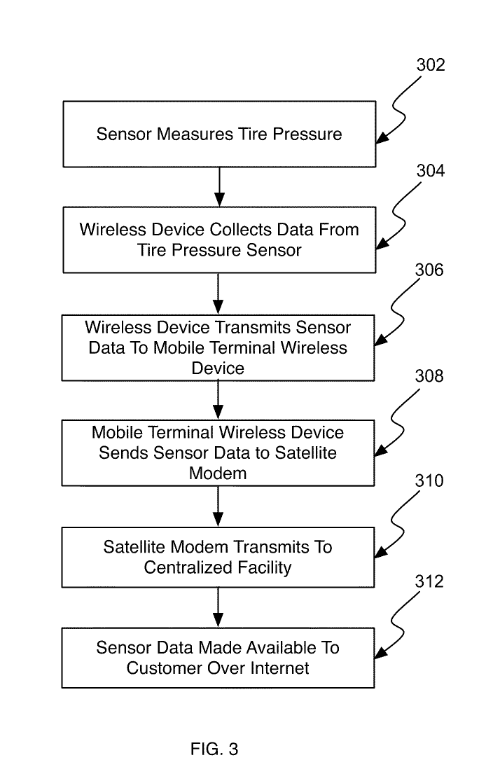

In one embodiment, a tire pressure sensor such as that exemplified by the AirBAT RF sensor manufactured by Stemco is coupled to a wireless device and deployed onto a wheel end. The function of such a combined device is now described with reference to the flowchart of FIG. 3.

As illustrated, the process begins at step 302 where the tire pressure sensor measures the tire pressure. At step 304, the wireless device would then collect the measurement data from the tire pressure sensor. At step 306, the wireless device transmits the sensor data to the mobile terminal wireless device. Here, the measurement data can be provided to a processor that would process the data. In one embodiment, the processor can be configured to determine what if any information to report depending on predefined criteria. For example, the processor can determine whether the current tire pressure reading is under a certain threshold. If the tire pressure reading is determined to be under a certain threshold, then the wireless device can choose to report the data to a centralized facility. Here, it should be noted that processing of measurement data can occur at any location, including the tire pressure sensor, the wireless device coupled to the tire pressure sensor, or at the mobile terminal.

If information is to be reported, the mobile terminal wireless device would then send the sensor data (raw or processed) to the satellite modem at step 308. The satellite modem would then transmit the information to the centralized facility at step 310. In one embodiment, the satellite modem would transmit the information to the centralized facility together with vehicle position information (i.e., a determined position or data enabling a determination of a position). Finally, at step 312, the centralized facility can make the sensor data available to a customer over the Internet.

In one embodiment, a low reading on the tire pressure sensor can be used to excite or activate the transmitting unit to process and send information to the centralized facility. As noted, satellite system position information can accompany this data in order to enable vehicle management personnel to locate and respond to an alert in a timely manner. In this way, potential accidents can be averted through the detection of a potentially dangerous condition in either the truck or the trailer.

In another example, a sensor can be used to monitor vehicle tires to ensure that a vehicle is not forced to operate on tires that have exceeded their life expectancy. Monitoring vehicle mileage is one way to avoid these situations. Indeed, early automatic detection of mileage-based maintenance events will enable the fleet operator to correct deficiencies early, avoid premature tire failure, reduce operating costs including fuel consumption, and improve vehicular safety.

In one embodiment, a sensor can be deployed on a tire hub to monitor the mileage of a tire or vehicle. One example of such a sensor is the Hubodometer manufactured by Stemco. In a similar manner to the tire pressure sensor, one or more mileage sensors can also be coupled to a mobile terminal via a wireless interface. This coupling would enable the mobile terminal to continually report, via satellite, the mileage for one or more tires.

One of the advantages of coupling the mobile terminal to a mileage sensor is the continual feedback regarding the relative use of the various vehicles in the fleet. As would be appreciated, performing a self-mileage check, or simply noting the accrued mileage during a maintenance visit would rely on human agency in the reporting process. Coordination of such manual reporting, in and of itself, would raise significant administrative issues. It is therefore a feature of the present invention that in-service mileage reporting can be done in an automated fashion using a satellite aided monitoring and tracking system that covers a large service area. This automated reporting process ensures that none of the vehicles equipped with a mileage sensor would be unaccounted for from a maintenance perspective.

Mileage reporting can also be coupled with position reporting. In one example, the position reporting would assist the fleet operator in identifying the closest maintenance facility should immediate action be required. As would be appreciated, the particular types of data that would be transmitted to the centralized facility would be implementation dependent. In one embodiment, the actual mileage data is sent, while in other embodiments, relative mileage readings since a previous event (e.g., vehicle servicing, last reported reading, etc.) are sent to the centralized facility.

The in-service vehicle reporting enabled by the satellite aided tracking and monitoring system can also provide valuable information regarding the actual operating condition of the vehicle. For example, a vehicle can be fitted with one or more sensors that can monitor and track tachometer and/or speedometer readings. This information would enable a supervising entity to monitor the driving habits of individual drivers, or monitor the general operation of a vehicle.

In one embodiment, the one or more sensors coupled to the tachometer and/or speedometer can record operational information and forward the raw data or data based on the raw readings to the centralized facility through the mobile terminal. The amount of data that is sent back to the centralized facility would be implementation dependent. In one example, only data indicative of operating conditions over some threshold (e.g., speeding situations, over-revving, etc.) would be reported to the centralized facility. In this example, the sensors can be designed to trigger a communication by the mobile terminal when a particular operating condition has been detected. In other examples, the mobile terminal can be designed to report periodic samples of operational data to the centralized facility. In one embodiment, the sensor information is also report to the centralized facility along with position information. In various embodiments, the tachometer/speedometer sensor can be coupled to the mobile terminal via a wired or wireless interface.

In addition to enabling bi-directional communications to and from a sensor device, it is a feature of the present invention that the local area wireless interface can enable system devices to be in a low power sleep mode most of the time, and only transmit for a short duration of time on a specified frequency or channel to conserve power. In one embodiment, the local area wireless interface uses a TDMA type communication protocol.

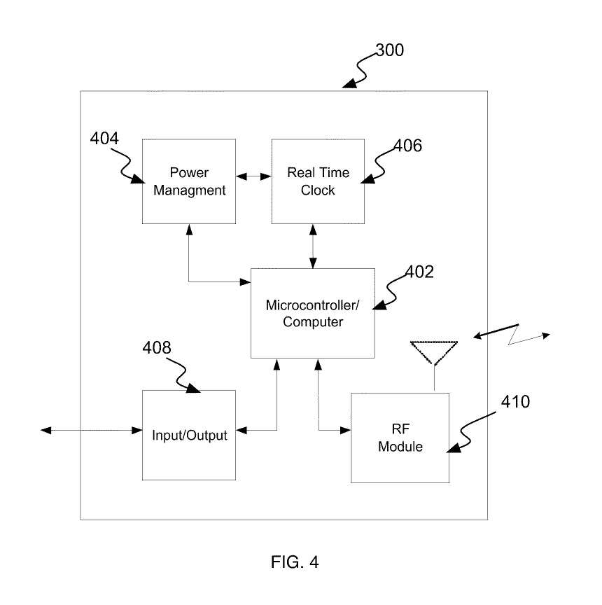

FIG. 4 illustrates an embodiment of a wireless device that has the ability to enter a low power state, and wake at a programmed time. As illustrated, wireless device 400 includes microprocessor 402, which is used to control the various functions, power management 404, which is used to power down and enter a low power state, real time clock 406, which wakes or powers-up the unit at a pre-determined time, input/output 408, which allows an interface to other devices, sensors, transducers, including the mobile terminal, and RF module 410, which performs the actual wireless communications. RF module 410 can be simple or complex. In one embodiment, RF module 410 would include a computer, a low-layer waveform and modulation technique, and its own protocol that could detect and correct errors and perform retries in order to reliably transmit and receive data.

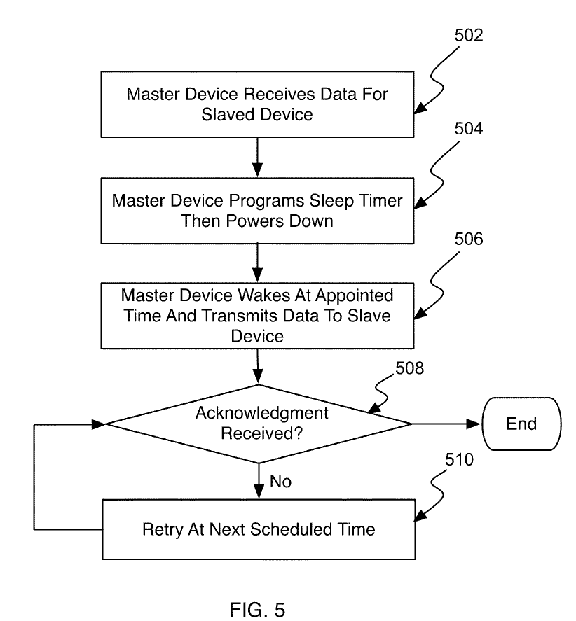

Having described an embodiment of a wireless device, an example of a data transfer over the low-power local-area wireless network is now provided with reference to the flowchart of FIG. 5. As illustrated, the process begins at step 502 where master device (e.g., WD(1)) is awakened and receives data from its I/O port for a particular slave device (e.g., WD(2)) and a sensor 130 that is attached to that slave device. The master device prepares this information for delivery and stores it. At step 504, the master device then programs a sleep timer to wake at the correct time then powers down. This wake time is the time the master device and the network protocol expects the receiving slave device to wake, assuming it is synchronized to the network. The master device can also compensate for time drifts and other physical layer issues.

At step 506, the master unit awakens at the scheduled time and transmits the information to the slave device. At step 508, the master device then determines whether an acknowledgment is received. In one embodiment, the slave device responds immediately. In another embodiment, both the master and slave device go back into a sleep mode and wake shortly thereafter for the slave device to send the acknowledgement.

If it is determined, at step 508, that the acknowledgment is not received, then the protocol would instruct both master and slave devices to try again at a later prescribed time, or wait for the next scheduled wakeup interval, depending on it configuration. If it is determined, at step 508, that the acknowledgment is received, then the data transfer process ends and the slave device would deliver the data to its attached sensor through its I/O port.

In one example, this process can be used to transmit configuration information to a sensor device. In another example, this process can be used to transmit a status request to a sensor device, wherein the sensor device's response would include measurement data taken by the sensor. This example illustrates an example of scheduled reporting through polling of the sensor device.

Event reporting can also be supported by the network protocol. Here, a sensor event can represent a detected change in monitored status (e.g., door opening, emptying of cargo, change in temperature, etc.), a detected change in operating state, or any other change detectable by a sensor. Information reflective of this detected event can then be prepared for transmission to the master device by the slave device, wherein the slave device sleeps until a scheduled time for transmission to the master device.

As described, the network protocol would enable the master and slave devices to sleep until a scheduled time when communication between the pair of devices on a known channel or frequency is expected to occur. This scheduled time would support a short communication between the two devices, which would ensure that the devices are only awakened for a minimal amount of time. The remaining time, which represents the vast majority of time, would be spent in a low power sleep mode.

In the description above, it is assumed that the network is synchronized such that the wake-up times are known by the individual devices. If the network is not synchronized, or the wake-up times are different, and/or channels or frequencies are different, the network protocol would enter a synchronization mode. In one embodiment, the synchronization process has all devices wake at some pseudo-random interval and channel until they find each other. The data transmitted would be small in order to minimize time and power consumption, while maximizing the probability of a hit or detection. Also, devices can be designed to slow themselves down or backoff after a period of time when it determines it is past the time where it normally synchronizes. This conserves power especially if the device has failed.

The synchronization process can also be expedited given some known information about the other devices that can or should be on the network such as their ID or group number. This information can be used in the network protocol, and in the synchronization process, particularly in the pseudo-random wake-up portion to increase the likelihood of a hit on both time and frequency. For example, this information can be used to force all devices onto the same channel or frequency, which eliminates the need to search the other frequencies, and reduces the synchronization time. This information can also be pre-programmed into each device during installation. Also, other information can be added at the factory, such as initializing the real time clocks such that the algorithm can pick times and frequencies based on the day to increase the probability of a hit, and reduce synchronization time. Synchronization can be further expedited by extraneous events such as manually pushing a button at approximately the same time on all devices on the network to initiate a momentary high rate of retries on the network. This type of event can cause all devices to use one pre-determined frequency and have each device remain powered continuously for a short duration, enough to allow all devices to enter this state and synchronize. While this mode consumes more power, it only needs to be in this mode for a short time since all the devices know that the others are also in this mode and awake.

Once a network is synchronized, the master and the network protocol can assign each device to a particular channel or frequency and wakeup time or slot. It can also broadcast additional information after the initial synchronization which will help each device more quickly synchronize in the future if it loses it's synchronization. The process that maintains synchronization can also use dithering to vary the wakeup times and frequencies on each wakeup in order to avoid collisions with other networks that may be within the same RF range.

Each individual network can also be designed to communicate to a global master device to send and receive broadcast information. An example of a global master device could be a hand-held diagnostic tool that acts as a master device except that it doesn't sleep and can continuously broadcast out to all devices since it has no power constraints. By continuously broadcasting, such a device can quickly reach all the devices in any network within RF range by waiting until their next wake up, where they can receive the broadcast information. When a device wakes on its scheduled time, which is completely different and random from devices on other networks, it can receive the broadcast information. This information would instruct the devices on what to do. One example is to command all devices to report their presence and status. The protocol can support this type of broadcast by allowing acknowledgements and retries. This way a hand held device can be used, for example, in a trucking yard to detect all networks within the yard to do an inventory. It can also be used to reprogram or reconfigure networks. This function of the network protocol allows devices to operate in different modes in order to perform maintenance, diagnostics, and operations.

As would be appreciated, various network protocols can be designed to operate the low-power local-area wireless network of the present invention. While the network protocol details can vary depending on the implementation, the network protocol is designed to satisfy a variety of functions other than the basic communication between master and slave devices. Some of the functions supported can include transferring data to and from a specific device, communicating scheduled and event data, auto detection of devices, configuring and reading status of devices, allowing diagnostic tools to use the network for configuration and re-programming, error handling, retrying failed communications, detecting collisions or interference from other low-power local-area wireless network, re-synchronizing timing of the devices, and automatically changing channels or frequencies.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A tire pressure monitoring system, comprising:
a satellite modem affixed to a vehicle;
a tire pressure sensor affixed to a wheel of said vehicle;
a first wireless device configured as a master device, said first wireless device interfacing with said satellite modem for delivery of tire pressure sensor data to a remote location; and
a second wireless device that is coupled to said tire pressure sensor, said second wireless device being configured as a slave device that enters into a low power state and awakens at a scheduled time for communication of said tire pressure sensor data to said first wireless device.

2. The system of claim 1, wherein said first wireless device is integrated with said satellite modem.

3. The system of claim 1, wherein said first wireless device is physically separate from said satellite modem.

4. The system of claim 1, wherein said satellite modem communicates position information along with tire pressure sensor data.

5. The system of claim 4, wherein said position information enables said remote location to calculate a position.

6. The system of claim 1, wherein said satellite modem communication occurs when the measured tire pressure crosses a threshold.

7. A tire pressure monitoring system, comprising:
a satellite modem affixed to a vehicle;
a mileage sensor affixed to a wheel of said vehicle;
a first wireless device configured as a master device, said first wireless device interfacing with said satellite modem for delivery of mileage sensor data to a remote location; and
a second wireless device that is coupled to said tire pressure sensor, said second wireless device being configured as a slave device that enters into a low power state and awakens at a scheduled time for communication of said mileage sensor data to said first wireless device.

8. The system of claim 7, wherein said first wireless device is integrated with said satellite modem.

10. The system of claim 7, wherein said first wireless device is physically separate from said satellite modem.

11. The system of claim 7, wherein said satellite modem communicates position information along with mileage sensor data.

12. The system of claim 11, wherein said position information enables said remote location to calculate a position.

13. The system of claim 7, wherein said satellite modem communication occurs when a mileage event occurs.
